(19) United States
(12) Patent Application Publication
(10) Pub. No.: US 2009/0303696 A1
(43) Pub. Date: Dec. 10, 2009

(54) DIFFUSION PLATE AND BACKLIGHT MODULE USING THE SAME

(75) Inventor: SHAO-HAN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/265,636

(22) Filed: Nov. 5, 2008

(30) Foreign Application Priority Data
Jun. 4, 2008 (CN) 200810302021.3

(51) Int. Cl. G09F 13/08; G02B 5/02

(52) U.S. Cl. 362/97.1; 359/599

(57) ABSTRACT

A diffusion plate formed includes a first surface and a second surface opposite to the first surface. The first surface defines a plurality of elongated arc-shaped grooves, and the second surface is flat. The first diffusion plate is formed by injection molding

### BACKGROUND

1. Technical Field

The present disclosure relates to a diffusion plate and a backlight module using the diffusion plate.

2. Description of the Related Art

Referring to FIG. 8, a typical direct type backlight module 100 includes a frame 11, a plurality of light sources 12, and a light diffusion plate 13. The light sources 12 are positioned in an inner side of the frame 11. The light diffusion plate 13 is positioned above the frame 11. The light diffusion plate 13 includes a plurality of diffusing particles (not shown) configured for diffusing light.

In use, light from the light sources 12 enters the diffusion plate 13 and becomes scattered. However, strong light spots of the light sources 12 are often formed above the light sources 12.

To enhance brightness within a predetermined viewing angle and avoid strong light spots, the typical backlight module 100 further includes a prism sheet 10 and a upper light diffusion film 14 positioned on the diffusion plate 13. The prism sheet 10 includes a transparent substrate 101 and a prism layer 103 formed on a surface of the transparent substrate 101. Referring to FIG. 9, a plurality of elongated V-shaped ridges 105 is formed on the prism layer 103. Scattered light leaves the diffusion plate 13, travels through the prism sheet 10, and is refracted out at the elongated V-shaped ridges 105, thereby enhancing the brightness within the predetermined viewing angle. The upper light diffusion film 14 is configured to diffuse the light to avoid the strong light spots.

However, although the upper light diffusion film 14 and the prism sheet 10 are in contacting each other, a plurality of air pockets exist around the boundaries of the upper light diffusion film 14 and the prism sheet 10. When light passes through the air pockets, some of the light undergoes total reflection along one or another of the corresponding boundaries. In addition, the upper light diffusion film 14 may absorb a certain amount of the light from the prism sheet 10. As a result, a brightness of light illumination of the backlight module 100 is reduced.

Therefore, a new diffusion plate is desired to overcome the above-described shortcomings.

### SUMMARY

A diffusion plate includes a first surface and a second surface opposite to the first surface. The first surface defines a plurality of elongated arc-shaped grooves, and the second surface is flat. The first diffusion plate is formed by injection molding.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present diffusion plate and backlight module using the same. Moreover, in the drawings, like reference numerals designate corresponding parts throughout several views, and all the views are schematic.

FIG. 1 is a cross-sectional view of a first embodiment of a backlight module, the backlight module including a first diffusion plate, a second diffusion plate, a plurality of light sources, and a frame.

FIG. 2 is an isometric view of the second diffusion plate of the backlight module of FIG. 1.

FIG. 3 is a photo showing an illumination distribution of light sources during testing without an optical plate.

FIG. 4 is a photo showing an illumination distribution of a backlight module during testing, consisting of the light sources of FIG. 3 and a prism sheet of FIG. 9 positioned on the light sources.

FIG. 5 is a photo showing an illumination distribution of a backlight module during testing, consisting of the light sources of FIG. 3 and the diffusion plate of FIG. 2 positioned on the light sources.

FIG. 6 is a cross-sectional view of a second embodiment of a second diffusion plate.

FIG. 7 is a cross-sectional view of a third embodiment of a second diffusion plate.

FIG. 8 is a cross-sectional view of a typical backlight module, the typical backlight module including a typical prism sheet.

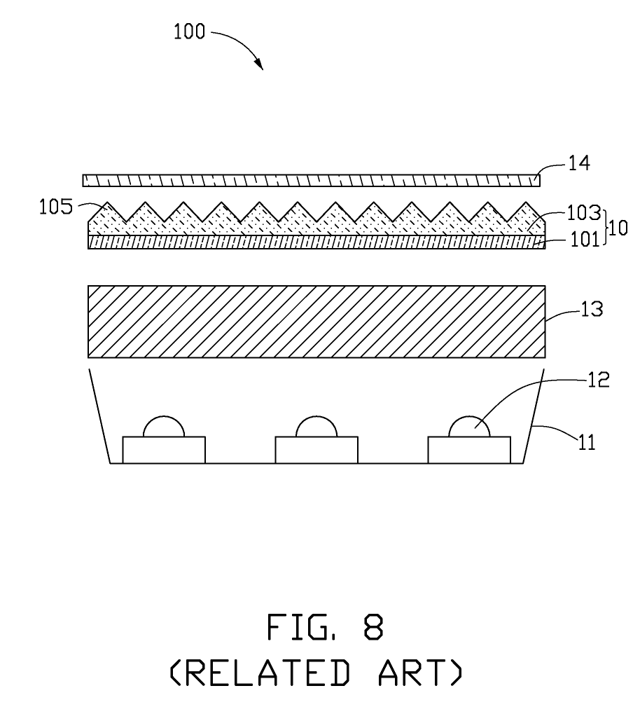

FIG. 9 is an isometric view of the typical prism sheet of the typical backlight module of FIG. 8.

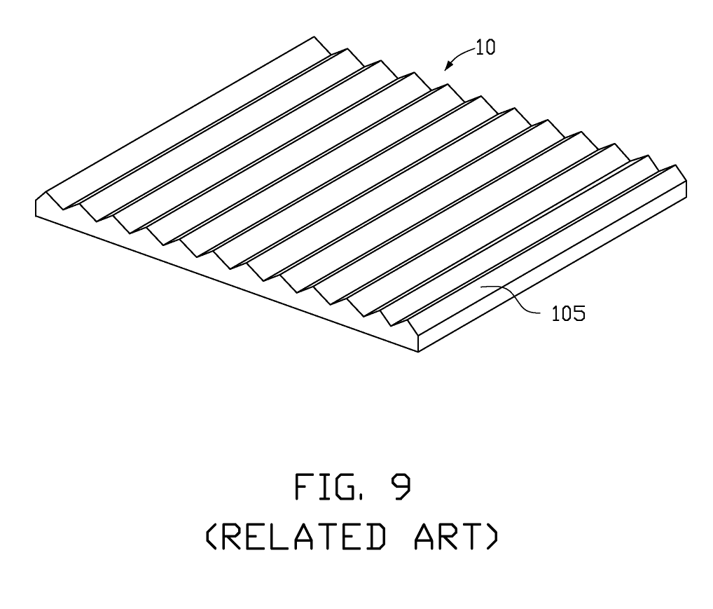

### DETAILED DESCRIPTION OF THE EMBODIMENTS

Reference will now be made to the drawings to describe embodiments of the present diffusion plate and backlight module using the same in detail.

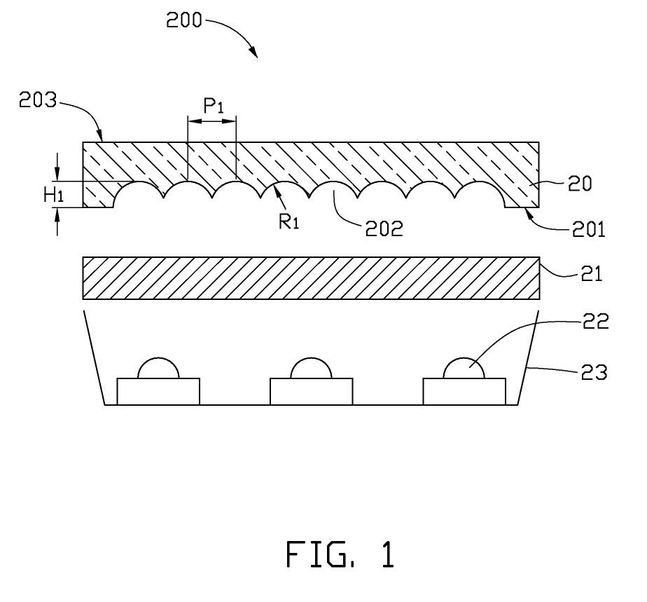

Referring to FIG. 1, a first embodiment of a backlight module 200 includes a second diffusion plate 20, a frame 23, a plurality of light sources 22 positioned on an inner side of the frame 23 facing the second diffusion plate 20, and a first diffusion plate 21 positioned between the second diffusion plate 20 and the light sources 22.

Light emitted from the light sources 22 enters the first diffusion plate 21 and becomes diffused. The diffused light then enters the second diffusion plate 20.

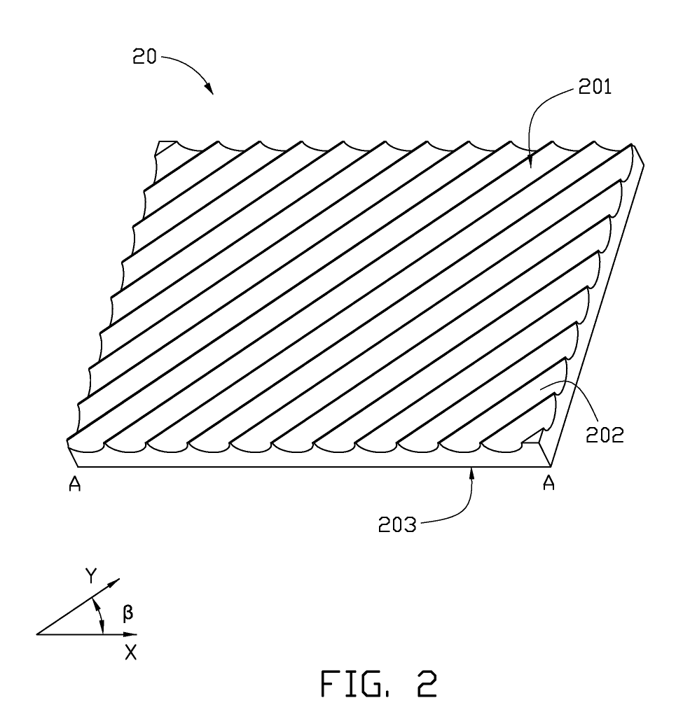

Referring to FIG. 2, the second diffusion plate 20 includes a first surface 201 and a second surface 203 opposite the first surface 201. In one embodiment, the first surface 201 faces the first diffusion plate 21 and the light sources 22. In addition, the first surface 201 defines a plurality of elongated arc-shaped grooves 202. The second surface 203 is flat. In another embodiment, the second diffusion plate 20 may be positioned such that the second surface 203 faces the light sources 22. The second diffusion plate 20 may be formed by injection molding.

The elongated arc-shaped grooves 202 are aligned side by side on the first surface 201 of the second diffusion plate 20. In the illustrated embodiment, each elongated arc-shaped groove 202 is circular. A pitch P₁ between adjacent elongated arc-shaped grooves 202 is in a range from about 0.025 millimeters to about 1.5 millimeters. In one embodiment, a radius R₁ of each elongated arc-shaped groove 202 satisfies the following expression: 0.01 millimeters≦R₁≦2P₁. A depth H₁ of each elongated arc-shaped groove 202 satisfies the following expression: 0.01 millimeters≦H₁≦R₁. In alternative embodiments, adjacent elongated arc-shaped grooves 202 may be spaced apart from each other by a predetermined interval. In another embodiment, each elongated arc-shaped groove 202 may be elliptical shaped.

An angle β defined by a Y-axis parallel to the elongated arc-shaped grooves 202 and a X-axis parallel to an edge AA of the second diffusion plate 20 may be in the range from about 40 to about 55 degrees. In the embodiment of FIG. 2, the angle β is about 45 degrees, the pitch P₁ between adjacent elongated arc-shaped grooves 202 is about 0.275 millimeters, the radius R₁ is about 0.1375 millimeters, and the depth H₁ is about 0.11 millimeters.

The second diffusion plate 20 may be made of a material selected from the group consisting of polycarbonate, polymethyl methacrylate, polystyrene, copolymer of methyl methacrylate and styrene, and any combinations thereof.

The frame 21 is made of a metal material or a plastic material. The frame 21 has highly reflective inner surfaces. In an alternative embodiment, a highly reflective film can be deposited on inner surface of the frame 21.

The light sources 22 may be linear light sources or point light sources, for example, light emitting diodes or cold cathode fluorescent lamps. In the embodiment of FIG. 1, each light source is a light emitting diode.

In use, since the inner surfaces of the elongated arc-shaped grooves 202 are curved, incident light that may have been internally reflected on a flat surface, are refracted, reflected, and diffracted. As a result, light outputted from the second diffusion plate 20 is more uniform than light outputted from a light output surface of a typical prism sheet and a brightness within a predetermined viewing angle is enhanced. Strong light spots of the light sources seldom occur. In addition, there is no need to add an extra upper light diffusion film. Thus, the efficiency of light utilization is enhanced and the number of components decreased.

Referring to the Table 1 below, test samples are provided.

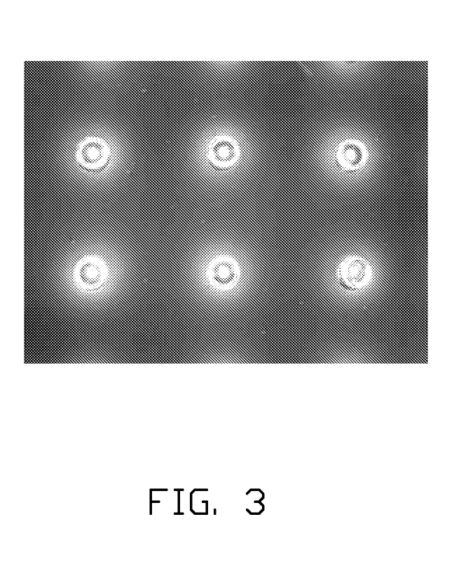

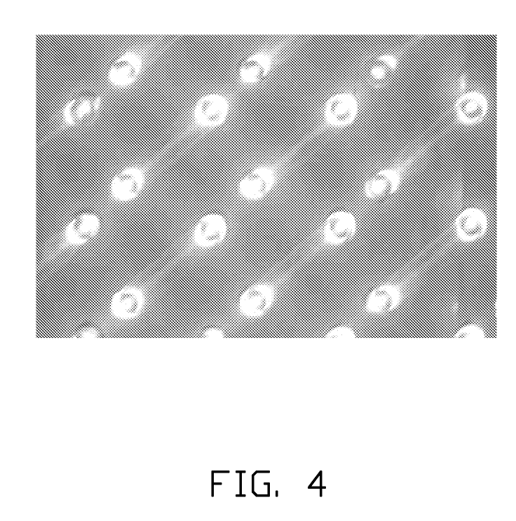

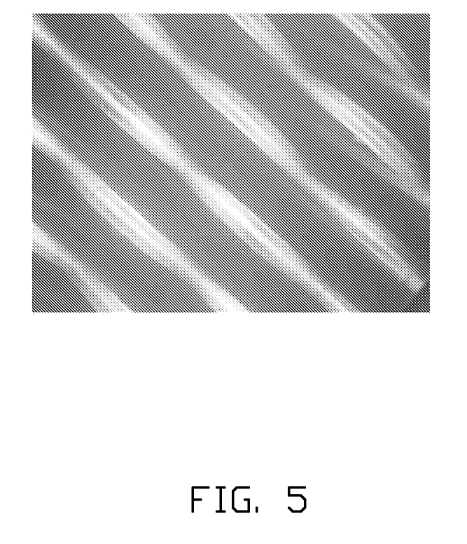

TABLE 1

| Test samples | Condition |
|---|---|
| 1 | light sources 22 without any optical plate (shown in FIG. 3) |
| 2 | light sources 22 + prism sheet 10 (shown in FIG. 4) |
| 3 | light sources 22 + diffusion plate 20 (shown in FIG. 5) |

FIGS. 3 through 5 reflect test results from the test conditions in Table 1. As can be seen, light spots formed on the typical prism sheet 10 is relatively strong, and in contrast, light spots formed on the second diffusion plate 20 is relatively weak. Therefore, the test results show that light emitting from the second diffusion plate 20 is more uniform. Therefore, when the second diffusion plate 20 is employed in a backlight module, strong light spots of the light sources seldom occur, more uniform light is achieved, and there is no need to add an upper light diffusion sheet. Thus, the efficiency of light utilization is enhanced. It may be appreciated that if a pitch between adjacent light sources is small enough, the first diffusion plate 21 in the backlight module 200 could be omitted.

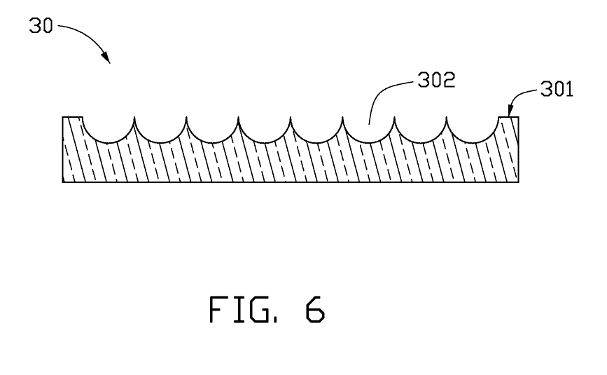

Referring to FIG. 6, a second embodiment of a second diffusion plate 30 is similar in principle to the first embodiment of the second diffusion plate 20, except that a plurality of elongated grooves 302 defined on a first surface is parabola-shaped.

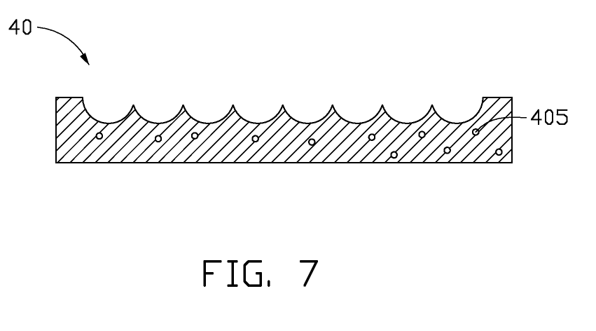

Referring to FIG. 7, a third embodiment of a second diffusion plate 40 is similar in principle to the second embodiment of the second diffusion plate 30, except that the second diffusion plate 40 includes a plurality of diffusion particles 405 dispersed in the diffusion plate 40 to enhance uniformity of light exiting the diffusion plate 40.

Finally, while the embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A diffusion plate comprising a first surface and a second surface opposite to the first surface, wherein the first surface defines a plurality of elongated arc-shaped grooves therein, and the second surface is flat; the first diffusion plate is formed by injection molding.

2. The diffusion plate of claim 1, wherein the elongated arc-shaped grooves are aligned side by side on the first surface.

3. The diffusion plate of claim 2, wherein an angle defined by a first axis parallel to the elongated arc-shaped grooves and a second axis parallel to an edge of the second diffusion plate is about 45 degrees.

4. The diffusion plate of claim 2, wherein a pitch between adjacent elongated arc-shaped grooves is a range from 0.025 millimeters to 1.5 millimeters.

5. The diffusion plate of claim 1, wherein each elongated arc-shaped groove has a shape selected from a group consisting of an elliptic arc, a parabola, and a circular arc.

6. The diffusion plate of claim 1, further comprising a plurality of diffusion particles dispersed in the diffusion plate.

7. The diffusion plate of claim 1, wherein the diffusion plate is made of a material selected from the group consisting of polycarbonate, polymethyl methacrylate, polystyrene, and copolymer of methylmethacrylate and styrene.

8. A backlight module, comprising:
a frame;
a plurality of light sources positioned in an inner surface of the frame; and
a first diffusion plate positioned above the light sources, wherein a first surface of the first diffusion plate defines a plurality of elongated arc-shaped grooves therein, and a second surface opposite the first surface is flat; the first diffusion plate is formed by injection molding.

9. The backlight module of claim 8, wherein the backlight module further comprises a second diffusion plate positioned between the light sources and the first diffusion plate.

10. The backlight module of claim 8, wherein the plurality of elongated arc-shaped grooves are aligned side by side.

11. The backlight module of claim 10, wherein an angle defined by a first axis parallel to the elongated arc-shaped grooves and a second axis parallel to an edge of the second diffusion plate is about 45 degrees.

12. The backlight module of claim 10, wherein a pitch between adjacent elongated arc-shaped grooves is a range from 0.025 millimeters to 1.5 millimeters.

13. The backlight module of claim 8, wherein each elongated arc-shaped grooves has a shape selected from a group consisting of an elliptic arc, a parabola, and a circular arc.

14. The backlight module of claim 8, wherein the first diffusion plate further comprises
a plurality of diffusion particles dispersed in the diffusion plate.

15. The backlight module of claim 8, wherein the diffusion plate is made of a material selected from the group consisting of polycarbonate, polymethyl methacrylate, polystyrene, and copolymer of methylmethacrylate and styrene.
